(19) United States
(12) Patent Application Publication
(10) Pub. No.: US 2010/0205827 A1
(43) Pub. Date: Aug. 19, 2010

(54) FOOT BUTLER

(76) Inventor: CURTIS ARNOLD, HENDERSON, NV (US)

Correspondence Address: LAW OFFICE OF JERRY D. HAYNES , P.A, P.O. Box 350392, Fort Lauderdale, FL, 33335, US

(21) Appl. No.: 12/389,364

(22) Filed: Feb. 19, 2009

(51) Int. Cl. F26B 19/00; F26B 25/00

(52) U.S. Cl. 34/572; 34/239

(57) ABSTRACT

The present invention relates to a foot drying apparatus comprising: a platform; a plurality of air blowers positioned at one end of the platform; flexible arms, where the flexible arms support the air blowers and extend from one end of the platform; and a power supply. The flexible arms include a conduit for the flow of forced air. The plurality of air blowers may direct either hot or room temperature air onto the platform to flow onto someone's feet that are positioned on the platform. The flexible arms enable a user to adjust the direction of the forced airflow as desired.

### BACKGROUND OF THE INVENTION

1. Field of Invention

The present invention relates to a foot care system specifically directed toward drying purposes.

2. Description of Related Art

Foot care is an important component of personal hygiene. Foot care and cleanliness has a couple of levels of application. Individuals may simply clean their feet while taking a daily shower or bath. Others may go further and specifically focus on the cleaning and pampering of their feet through pedicures or foot baths. In either instance, it is necessary to dry one's feet as some point in the process. Using a dry towel is one common method to dry one's feet. However, it may require several wipings to thoroughly dry one's feet. Using a towel usually requires considerable effort to completely dry one's feet.

The prior art reveals several devices and methods for foot drying that involve the direction of forced air over and around one's feet. Particular attention is noted to U.S. Pat. No. 3,378,009 which discloses a foot conditioning apparatus that comprises a housing with two foot rests. The foot rests provide a means for the individual to place his or her feet and directs the toes in a spread condition in order to allow a stream of heated air to transmit over the feet and to dry the feet which afterwards a powder or medication is sprayed onto the toes. When placed in the foot rest the toes are directly under a vent which provides a means for the airflow.

Another prior art reference that is noteworthy includes U.S. Pat. No. 4,782,601 which discloses a foot drying assembly designed to be on a supporting surface such as a floor where a support platform includes an aperture to a grid structure. As contemplated by the '601 Patent, heated air passages are provided through the grid structure and substantially surround the bottom and side portions of the feet and toes. Further air vents are placed at the front portion of the housing that direct heat over the front portion of the foot.

U.S. Pat. No. 5,613,304 discloses yet another foot drying apparatus that is incorporated into a weight scale. The foot dryer of the '304 Patent includes a heater and fan that blow air into air chambers that transfer onto the soles of the user's feet. The air chambers consequently provide air that may be hot or at room temperature.

As noted with the prior art, the direction of the air is stationary as are the feet in the footrest positions provided on the foot drying devices known. It would be advantageous to have adjustable airflow direction for an individual to accommodate all angles of one's foot while drying.

### SUMMARY OF THE INVENTION

The present invention relates to a foot drying apparatus comprising: a platform; a plurality of air blowers positioned at one end of the platform; flexible arms, where the flexible arms support the air blowers and extend from one end of the platform; and a power supply. The flexible arms include a conduit for the flow of forced air. The plurality of air blowers may direct either hot or room temperature air onto the platform to flow onto someone's feet that are positioned on the platform. The flexible arms enable a user to adjust the direction of the forced airflow as desired.

Other features of the present invention include a control panel that provides a means to activate and deactivate the foot drying apparatus. The control panel may be foot or hand operated and may include a LED display. In an alternative embodiment, the foot drying apparatus may include a control sensor that is activated upon depression of the platform and deactivated upon relieving the depression of the platform.

### BRIEF DESCRIPTION OF DRAWINGS

FIG. 1a shows a top view of a foot butler according to present invention.

FIG. 1b shows a side profile view of the foot butler according to the present invention.

### DETAILED DESCRIPTION

The present invention provides a unique and novel device and method to dry one's feet after showering or a footbath. The present invention uses forced air directed over one's feet and provides the user a means to adjust the direction of the forced air in order to facilitate a thorough drying experience.

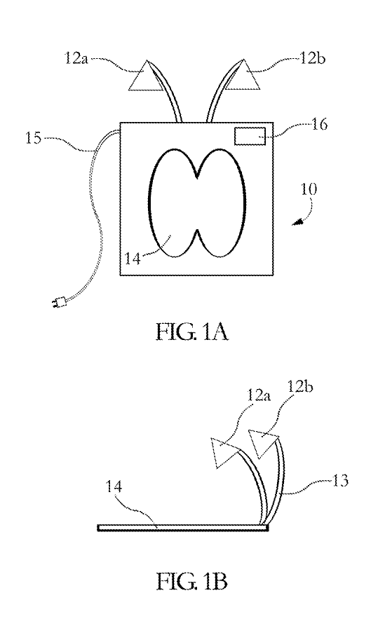

A foot butler 10 as shown in FIG. 1a includes a foot stand 14 that provides a platform for one to stand while using the foot butler 10. A control panel 16 is also shown in the upper right hand corner of the foot stand 14. The control panel 16 may be located at other positions on the foot stand 14 however the current position provides a means for the control panel 16 to be visible and accessible to the user. The control panel 16 may be foot operated or one may use a hand and bend down to operate the control panel 16. The foot butler 10 may be placed upon the floor or ground while the user stands upon the foot stand 14 during use.

The foot butler 10 includes blowers that are positioned at the top end of the foot stand 14. Blowers 12a, 12b extend upwardly and over the feet so air is directed downward on the feet. The blowers 12a, 12b include flexible blowing arms 13 that bend and are adjustable by the user. The bending flexible arms 13 enable the user to direct the forced air which is transmitted through the blowers at a suitable direction.

The blowers 12a, 12b transmit either hot or room temperature air in order to facilitate the drying of one's feet. The foot butler 10 is an electrically powered device that includes power supply 15. The control panel 16 in addition to having switches to activate and deactivate the foot butler 10 may also include a light or LED indicator designating that the foot butler 10 is in an on or off position.

FIG. 1b shows a side profile view of the foot butler 10. As seen from the side view the flexible arms 13 may be bent at various horizontal levels in order to increase or decrease the strength of the forced air that is directed over the feet. Also the flexible arms 13 may move sideways or horizontally so that the air can be directed to the sides of the individual's feet.

Other features that may be associated with the foot butler 10 include an automated sensor, not shown, which may activate the foot butler 10 upon an individual's standing on the foot stand 14. The use of a sensor negates the necessity for an individual to activate the foot butler 10 into an on or off position. Once the individual steps onto the foot stand the foot butler 10 airflow activates. When a person steps off the foot butler 10 after completing the drying process, the air blowers to the foot butler 10 may automatically shut off.

The present invention overcomes some of the shortcomings associated with the prior art in that the forced air direction is flexibly directed at the user's desire. Also the foot butler 10 may be designed in a sleek and stylistic design making it convenient to use in many applications. Further the flexible blower arms 13 allow for easy storage of the foot butler 10 when not in use. The foot butler 10 may be placed just outside one's bathtub or shower area so that an individual may stand on the foot butler 10 while drying other portions of their body.

Due to the convenient ability to use the foot butler 10, one may be able to prevent fungus or odor that may develop on one's foot. Further the thorough drying of the feet may help prevent athlete's foot and provides a method to diminish the development of fungus. The surface of the foot stand 14 may be made of a soft rubber pliable material in order to reduce the risks of slipping if one stands on the foot butler 10 during use. The foot butler 10 may also be used while one is sitting down and is applicable to use in a pedicure shop.

What is claimed is:

1. A foot drying apparatus comprising:
a. a platform;
b. a plurality of air blowers positioned at one end of the platform;
c. flexible arms, where the flexible arms support the air blowers and extend from one end of the platform; and
d. a power supply.

2. The foot drying apparatus according to claim 1, where said flexible arms include a conduit for the flow of forced air.

3. The foot drying apparatus according to claim 1, where said plurality of air blowers direct at least one of hot and room temperature air onto the platform.

4. The foot drying apparatus according to claim 1, where the flexible arms enable a user to adjust the direction of the forced air flow.

5. The foot drying apparatus according to claim 1, further comprising:
a. a control panel where said control panel provides a means to activate and deactivate the foot drying apparatus.

6. The foot drying apparatus according to claim 5, where said control panel includes a LED display.

7. The foot drying apparatus according to claim 1, further comprising:
a. a control sensor, where said control sensor is activated upon depression of the platform and deactivated upon relieving the depression of the platform.

8. The foot drying apparatus according to claim 1, where the platform includes a pliable surface.
